(19) United States
(12) Patent Application Publication
(10) Pub. No.: US 2005/0094403 A1
(43) Pub. Date: May 5, 2005

(54) High brightness flat panel display

(76) Inventor: Hong-Da Liu, Jubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/811,216

(22) Filed: Mar. 26, 2004

(30) Foreign Application Priority Data
Oct. 31, 2003 (TW) 92130598

(51) Int. Cl. F21V 7/04

(52) U.S. Cl. 362/318

(57) ABSTRACT

A flat panel display with high brightness. The flat panel display comprises a panel and a light module. The panel has a plurality of pixels. The transmittivity of each pixel or the ratio of the transmissive area of each pixel to the area of the pixel exhibits a first distribution function. The light module supplies light to illuminate the panel. The intensity of the light exhibits a second distribution function. In the flat panel display, the distribution of the brightness of the panel is improved by controlling of the transmittivity of each pixel or the area ratio of the transmissive area, to attain a better visual quality.

### BACKGROUND OF THE INVENTION

1. Field of the Invention

The present invention relates to a flat panel display, and in particular to a flat panel display with high brightness.

2. Description of the Related Art

As shown in FIG. 1, a conventional transflective flat panel display 100 comprises a panel 102 and a light module 104. 106 and 108 represent top views of the pixels located in the central region 114 and the peripheral region 116 of the panel 102, respectively. FIG. 2 shows magnified view of the pixels 106 and 108 in FIG. 1. The interlaced-line area 110 is a reflective area, and the blank area 112 is a transmissive area. The reflective area 110 occupies about 30% of the entire pixel area, the transmissive area about 60%, and the remaining area (which may be shielded and not shown in the drawings), about 10%. In the display 100, all the pixels 106 and 108 on the panel 102 have the same structure, that is, every reflective area 110 occupies the same amount of area, and every transmissive area 112 occupies the same amount of area. Therefore, the brightness of the reflected light at every position on the display 100 is identical, as shown by the curve 118 in FIG. 4.

FIG. 3 shows the brightness supplied by the light module 104 to the panel 102. The brightness supplied to the central region 114 is assumed 100%. The brightness supplied to the peripheral region 116 is assumed 80%. Since the brightness supplied by the light module 104 decreases from the central region to the peripheral region, the brightness of the transmitted light on the display 100 also decreases from the central region to the peripheral region, as shown by the curve 120 in FIG. 4. The brightness of the transmitted light in the central region 114 is about 60%. The brightness of the transmitted light in the peripheral region 116 is about 48%. Generally, the human eye cannot perceive any difference between the highest and lowest brightness on the display when the ratio of the difference to the highest brightness is less than 20%. Thus, a user will not perceive the brightness difference between the central region 114 and the peripheral region 116 when viewing the display. Additionally, the display quality is better when the brightness of the central region is higher than that of the peripheral region.

However, the reflective area of each pixel on a conventional flat panel display 100 is identical, thus the brightness of reflected light is identical. If the brightness of the central region of a display can be enhanced to exceed that of the peripheral region, the viewers will be able to perceive a greatly enhanced brightness on the display, therefore, the display quality will be improved. Hence, a flat panel display with the described characteristics is called for.

### SUMMARY OF THE INVENTION

Accordingly, an object of the invention is to provide a flat panel display.

According to one embodiment of the present invention, the flat panel display with high brightness comprises a panel having a plurality of pixels and a light module supplying light to illuminate the panel. Each of the pixels comprises at least one reflective area and at least one transmissive area. The ratio of the transmissive area of each pixel on the panel to the area of the pixel varies according to the distance from the pixel to the central position of the panel and exhibits a first distribution function. The intensity of light exhibits a second distribution function. The light module further comprises a light source for supplying light and a light guide plate for guiding the light to the panel.

According to another embodiment of the present invention, the flat panel display with high brightness comprises a panel having a plurality of pixels and a light module supplying a light to illuminate the panel. Each of the pixels has indices reflectivity and transmittivity. The transmittivity of each pixel on the panel varies according to the distance from the pixel to the central position of the panel and exhibits a first distribution function. The intensity of light shows a second distribution function. Furthermore, the light module comprises a light source for supplying light and a light guide plate for guiding the light to the panel.

In the present invention, the reflected light brightness of the panel is improved by altering the area ratio or transmittivity of the transmissive areas of the plurality of pixels on the panel to exhibit a first distribution function, preferably a function complementary to a Gaussian function. The transmitted light brightness, however, decreases when the reflected light increases. Therefore, the light supplied by the light module is adjusted to avoid the reduction of the transmitted brightness of the panel, without increasing the power of the light module. The intensity of the light supplied is adjusted to exhibit a second distribution function to illuminate on the panel in accordance with the distribution of the transmittivity on the panel. Preferably, the second distribution function is a Gaussian function.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing a conventional transflective liquid crystal display;

FIG. 2 is a magnified view of the pixel shown in FIG. 1;

FIG. 3 is a graph showing brightness levels provided by the light module shown in FIG. 1 corresponding to different positions thereof;

FIG. 4 is a graph showing reflected and transmitted light brightness of the display shown in FIG. 1 corresponding to different positions thereof;

FIG. 5 is a schematic view showing a flat panel display of an embodiment according to the present invention;

FIG. 6 shows a curve obtained by plotting the area ratio of the transmissive area or the transmittivity versus the position of the panel according to the present invention;

FIG. 7 is a schematic view of the reflected light brightness resulting from reflection of external light in an embodiment of the present invention;

FIG. 8 is a graph showing light intensity supplied by the light module corresponding to different positions thereof;

FIG. 9 is a graph showing the reflected and transmitted light brightness corresponding to different positions thereof in an embodiment according to the present invention;

FIGS. 10A to 10D show the illustrative variations of the transmissive areas of pixels;

FIG. 11 is a schematic view of the semi-transmissive metal layer;

FIG. 12A shows an illustrative example of light module 206;

FIG. 12B shows another illustrative example of light module 206;

FIG. 13A is a schematic view of a display using a backlight plate;

FIG. 13B is a schematic view of a display using a frontlight plate;

FIG. 14 is a 3-dimensional schematic view of the curve shown in FIG. 6;

FIG. 15 is a 3-dimensional schematic view of the curve 222 shown in FIG. 8.

### DETAILED DESCRIPTION OF THE INVENTION

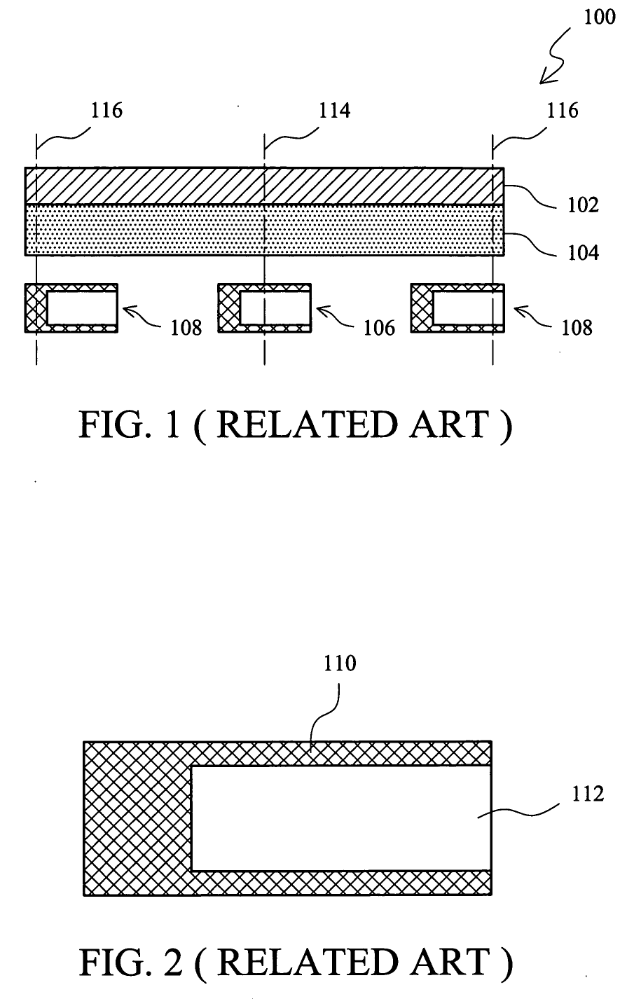

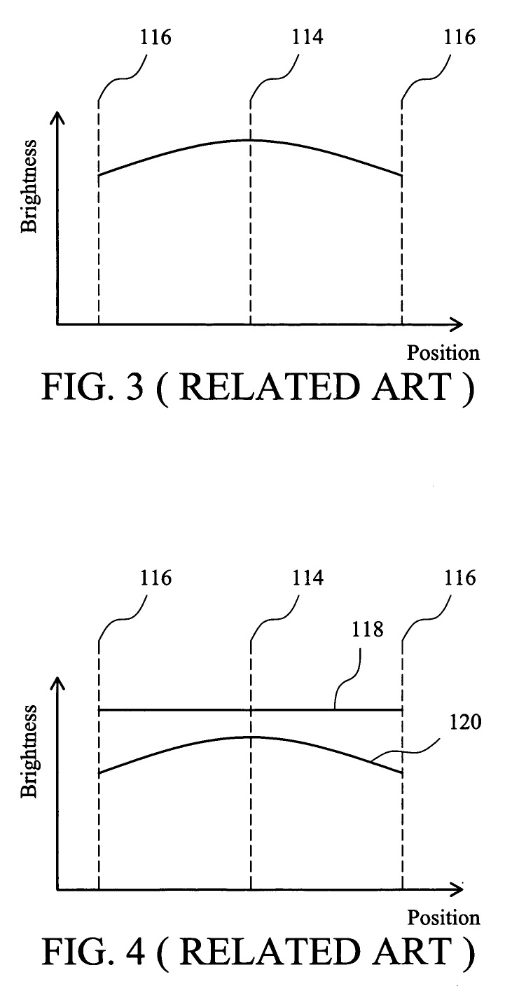

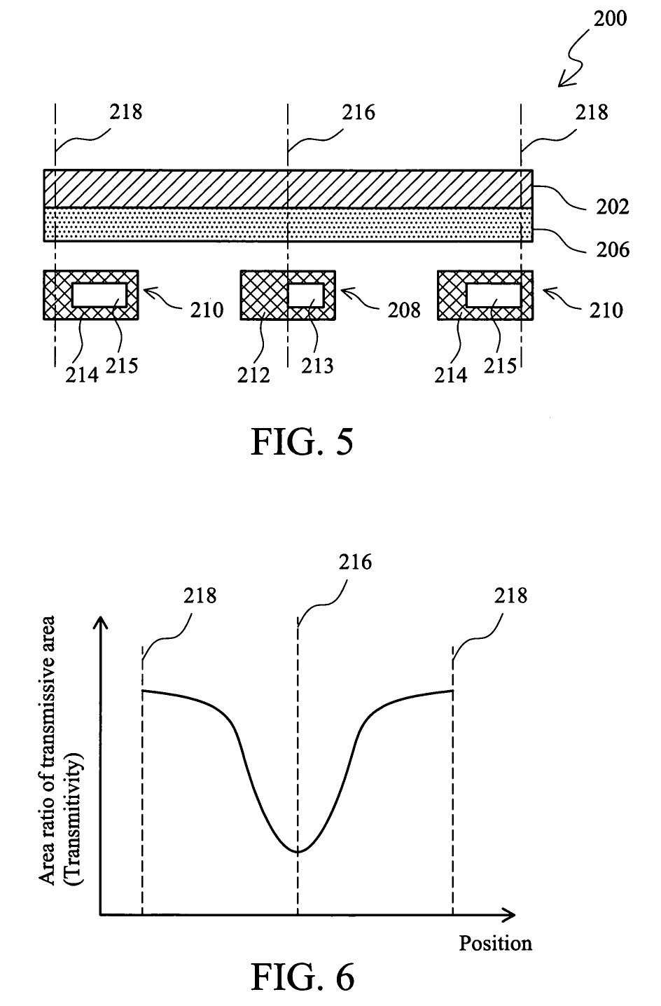

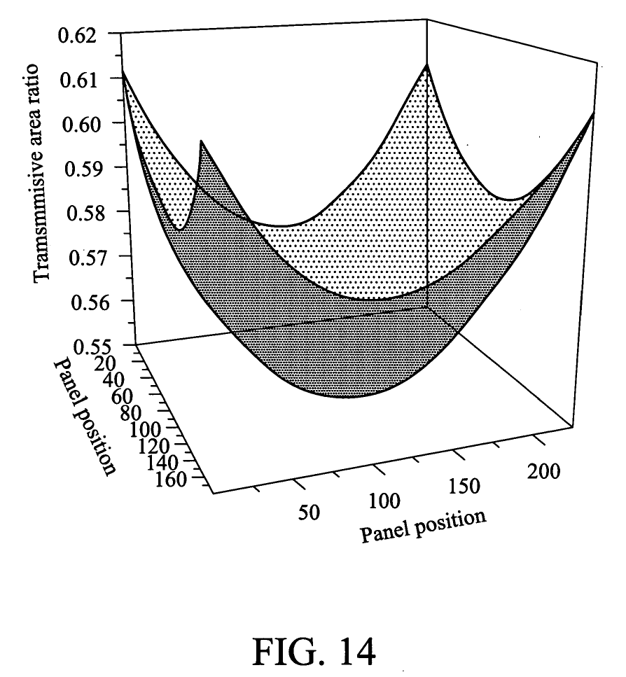

FIG. 5 shows a flat panel display 200 of an embodiment according to the present invention, which comprises a panel 202 and a light module 206. There are a number of pixels 208 and 210 on the panel 202. The light module 206 supplies light to the panel 202. Pixels 208 and 210 are in the central region 216 and the peripheral region 218 of the panel 202, respectively, as shown in a top view in FIG. 1. Areas 212 and 214 with interlaced lines in the pixels 208 and 210 represent reflective areas, and areas 213 and 215 represent transmissive areas. In this embodiment, as shown in FIG. 5, the reflective area 212 of the pixel 208 in the central region 216 is larger than the reflective area 214 in the peripheral region 218. In view of integration, the area ratio of the transmissive areas of the plurality of pixels on the panel 202 has a distribution function. In this embodiment, the distribution function is a continuous function complementary to a Gaussian function, as shown in FIG. 6. The function is A−exp[−α(x²+y²)], wherein parameter A is equal to or greater than 0.3 and equal to or less than 5, parameter α is equal to or greater than 10⁻⁸ and equal to or less than 10⁻⁴, and x and y represent the pixel position of panel, respectively. FIG. 14 is a 3-dimensional schematic view for the curve shown in FIG. 6.

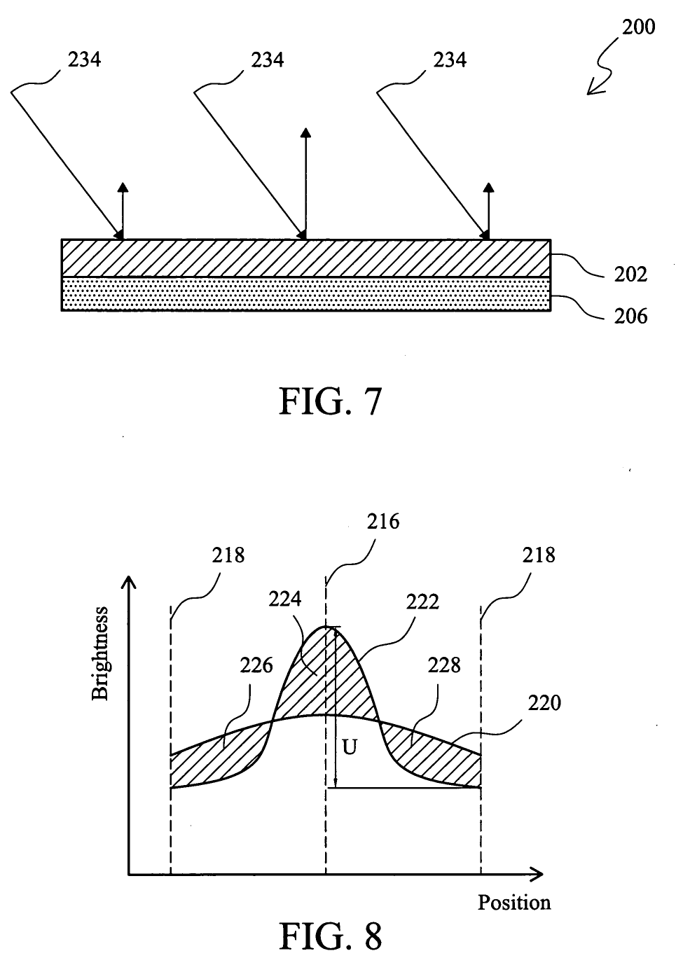

Please refer to FIGS. 5 and 6. For the flat panel display 200 of the embodiment, the area ratio of the transmissive areas of all pixels on the panel 202 has a continuous distribution function complementary to a Gaussian function, as shown in FIG. 6. The transmissive area closer to the central region of the pixel 216 has small area. The reflective area 212 of the pixel 208 in the central region 216 occupies 35% of the total area of the entire pixel, and the transmissive area 213 occupies. 55%; while the reflective area 214 of the pixel 210 in the peripheral region 218 occupies 29.8% of the total area of the entire pixel, and the transmissive area 215 occupies 60.3%. In this embodiment, the area of the reflective area 212 in the display 200 gradually decreases from the periphery to the center, thus the reflected light brightness resulting from reflection of the external light 234 is also higher in the center than in the periphery, as shown in FIG. 7.

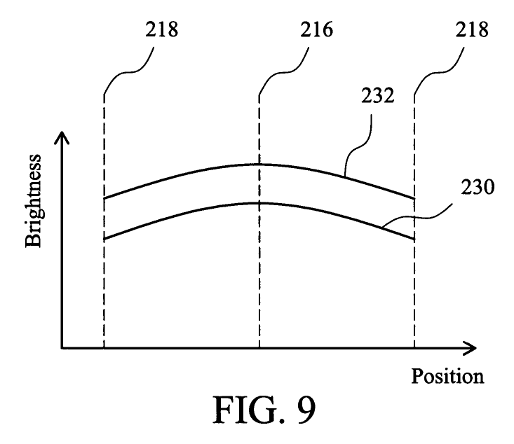

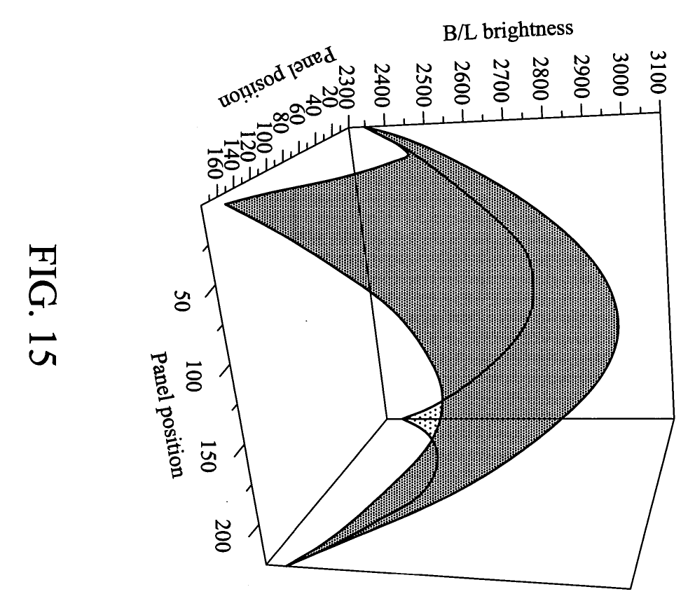

The area occupied by the transmissive area 213 of the pixel 208 in the central region 216 of the panel 202 is less than that of the transmissive area 215 of the pixel 210 in the peripheral region 218, as shown in FIG. 5. Therefore, to prevent the brightness of the central region 216 of the display 200 from being lower than the brightness of the peripheral region 218, the intensity of the light supplied to the panel 202 by the light module is adjusted to form a distribution function according to various pixel positions. The distribution is, for example, a Gaussian function, as shown by the curve 222 in FIG. 8, corresponding to the change of the ratio of the transmissive areas of the pixels. The function for the curve 222 is Bexp[β(x²+y²)], wherein parameter B is backlight intensity, parameter β is equal to or greater than 10⁻⁷ and equal to or less than 10⁻³, and x and y represent the position of pixel, respectively. FIG. 15 is a 3-dimensional schematic view for the curve 222. In this embodiment, the light supplied by the light module 206 is gathered to the center of the panel 202, such that the brightness of the central region 216 of the display 200 is not lower than that in the peripheral region 218, as shown by the curve 232 in FIG. 9.

FIG. 8 is a graph showing the relation between the light intensity supplied by the light module 206 in the display 200 according to the present invention and the panel position. The curve 220 represents the light intensity supplied by the light module of a conventional display at various positions, and the curve 222 represents the light intensity supplied by the light module 206 used in the present invention, in which the curve 222 is a Gaussian curve. The ratio of the difference, U, between the highest and the lowest brightness of the light module according to the present invention to the highest brightness is within the range of 30% to 70%. In FIG. 8, three areas 224, 226, and 228 are positioned between the curves 220 and 222. The area 224 must be equal to the sum of the areas 226 and 228, so that the power consumed by the light module 206 does not exceed that of a conventional light module.

According to the above description, the relationship of the intensity of the reflected and transmitted light of the flat panel display 200 according to the present invention and the position thereof can be obtained, as shown in FIG. 9. The curve 230 represents the brightness of the reflected light at various positions and the curve 232 represents the brightness of the transmitted light at various positions. The curve 230 can be obtained by multiplying the display 200 illuminated by external light by the area ratio of the reflective area of each position on the display 200. The curve 232 can be obtained by multiplying the display 200 illuminated by the light module by the area ratio of the transmissive area of each position on the display 200.

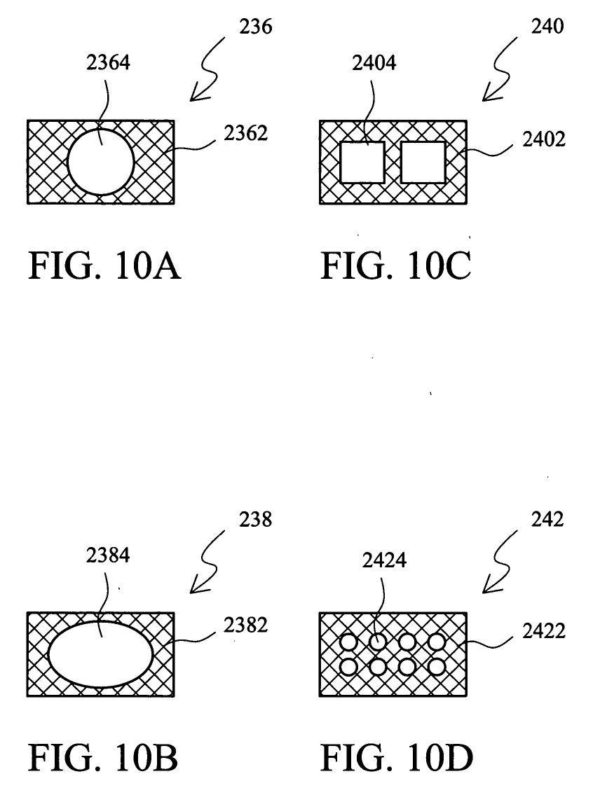

In the present invention, the transmissive area of the pixel on the panel 200 may have various shapes. Four illustrative examples are shown in FIGS. 10A to 10D, wherein areas 2362, 2382, 2402, and 2422 with interlaced lines of pixels 236, 238, 240, and 242 are reflective areas. The transmissive area 2364 of the pixel 236 is circular. The transmissive area 2384 of the pixel 238 is elliptical. The transmissive area 2404 of the pixel 240 comprises two rectangles. The transmissive area 2424 of the pixel 242 comprises a number of small circles.

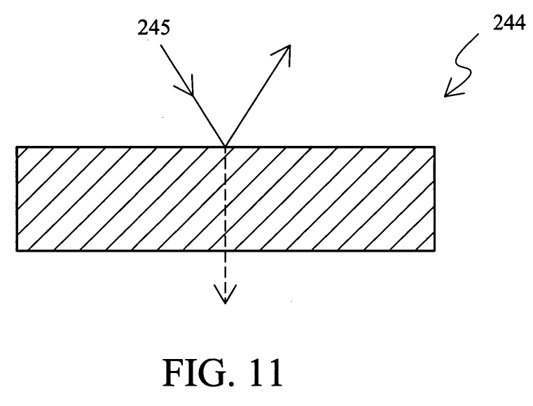

Furthermore, the pixels on the panel 202 may be a semi-transmissive metal layer 244, as shown in FIG. 11, which has indices of transmittivity and reflectivity. When a light 245 is incident on the semi-transmissive metal layer 244, part of the light 245 is transmitted through the semi-transmissive metal layer 244, and the remainder of the light 245 is reflected by the semi-transmissive metal layer 244. Likewise, by controlling the reflectivity or transmittivity of every semi-transmissive metal layer 244 on the panel 202 and allowing it to exhibit a distribution function, for example, a Gaussian function, improved brightness is achieved. In other embodiments, a multilayered film having indices transmittivity and reflectivity may be used to replace the semi-transmissive metal layer 244.

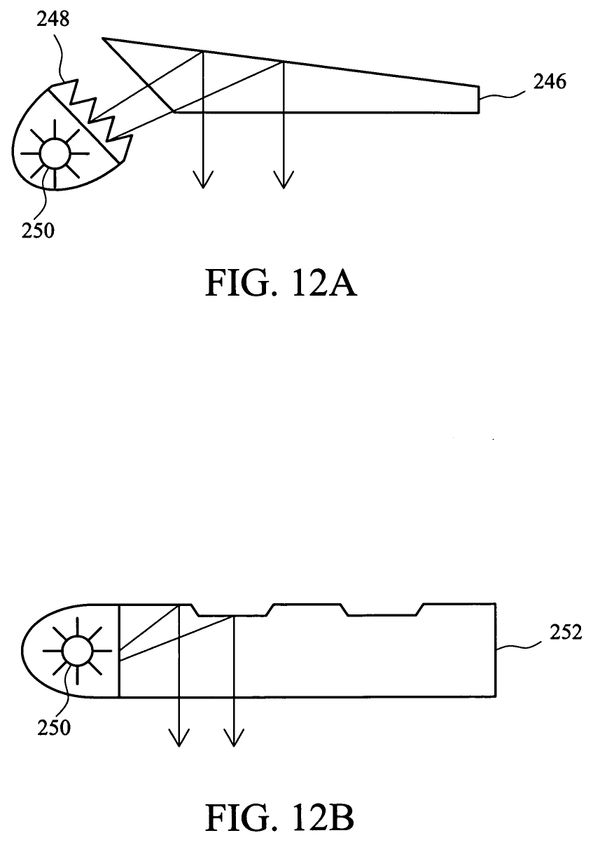

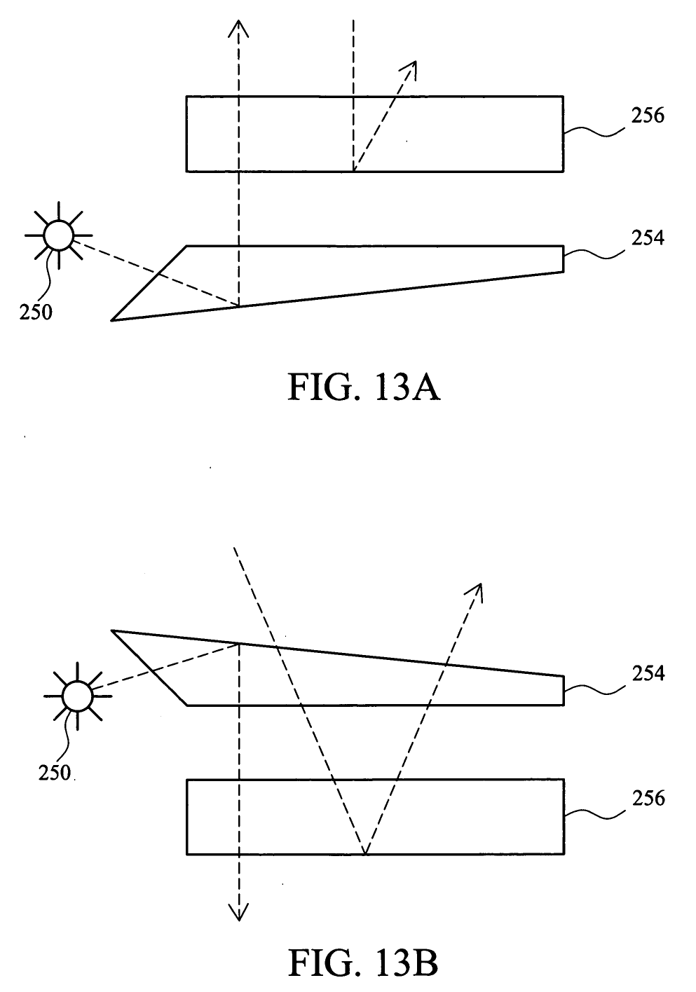

The structure of light module 206 may vary. FIG. 12A shows an exemplary light module, which comprises a light guide plate 246 with an inclined plane structure, a prism 248, and a light source 250. The light guide plate 246 and the light source 250 are separated. The prism 248 gathers and directs the light supplied by the source 250 to the light guide plate 246. The light guide plate 246, then, guides the light to the display. FIG. 12B shows another exemplary light module, which comprises a light guide plate 252 with a plane structure and a light source 250. The light guide plate 252 and the light source 250 are combined. Similarly, the light guide plate 252 guides the light supplied by the light source 250 to the display. FIGS. 13A and 13B show the positional relationship of the light guide plate and the panel. In FIG. 13A, the light guide plate 254 functions as a light module and is disposed behind the panel 256. In FIG. 13B, the light guide plate 254 functions as a frontlight plate and is disposed in front of the panel 256.

The liquid crystal injected into the display according to the present invention may be twisted nematic, super twisted nematic, vertical aligned, or mixed-mode twisted nematic and the display may be TFT-LCD, TFD-LCD, LTPS-LCD, electrophoresis display, or other flat panel display.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A flat panel display, at least comprising:
a panel having a plurality of pixels, wherein each of the pixels comprises at least one reflective area and at least one transmissive area and the ratio of the transmissive area of each pixel on the panel to the area of the pixel varies according to the distance from the pixel to the central position of the panel and exhibits a first distribution function; and
a light module supplying light to illuminate the panel, wherein the light intensity exhibits a second distribution function.

2. The display as claimed in claim 1, wherein the light module comprises:
a light source supplying the light; and
a light guide plate guiding the light to the panel.

3. The display as claimed in claim 2, which further comprises a prism between the light source and the light guide plate to direct the light to the light guide plate.

4. The display as claimed in claim 2, wherein the light guide plate has an inclined plane structure.

5. The display as claimed in claim 2, wherein the light guide plate has a plane structure.

6. The display as claimed in claim 2, wherein the light guide plate is a backlight plate.

7. The display as claimed in claim 2, wherein the light guide plate is a frontlight plate.

8. The display as claimed in claim 1, wherein the transmissive area is circular, rectangular, or elliptical.

9. The display as claimed in claim 1, wherein the first distribution function is a function complementary to a Gaussian function.

10. The display as claimed in claim 1, wherein the first distribution function is a continuous function.

11. The display as claimed in claim 1, wherein the second distribution function is a Guassian function.

12. The display as claimed in claim 1, wherein the second distribution function is a continuous function.

13. The display as claimed in claim 1, wherein the product of the first distribution function and the second distribution function is a continuous function.

14. The display as claimed in claim 1, wherein the ratio of the difference between the highest brightness and the lowest brightness supplied by the light module to the highest brightness supplied by the light module is within the range of 30% to 70%.

15. The display as claimed in claim 1, wherein the ratio of the area of the transmissive area or the reflective area of the center pixel to the area of the transmissive area or the reflective area of the outermost pixel is between 0.2 and 5.

16. A flat panel display, at least comprising:
a panel having a plurality of pixels, wherein each of the pixels has indices of reflectivity and transmittivity and the transmittivity of each pixel on the panel varies according to the distance from the pixel to the central position of the panel and exhibits a first distribution function; and
a light module supplying light to illuminate the panel, wherein the light intensity exhibits a second distribution function.

17. The display as claimed in claim 16, wherein the light module comprises:
a light source supplying the light; and
a light guide plate guiding the light to the panel.

18. The display as claimed in claim 17, which further comprises a prism between the light source and the light guide plate to direct the light to the light guide plate.

19. The display as claimed in claim 17, wherein the light guide plate has an inclined plane structure.

20. The display as claimed in claim 17, wherein the light guide plate has a plane structure.

21. The display as claimed in claim 17, wherein the light guide plate is a backlight plate.

22. The display as claimed in claim 17, wherein the light guide plate is a frontlight plate.

23. The display as claimed in claim 16, wherein the first distribution function is a function complementary to a Gaussian function.

24. The display as claimed in claim 16, wherein the first distribution function is a continuous function.

25. The display as claimed in claim 16, wherein the second distribution function is a Gaussian function.

26. The display as claimed in claim 16, wherein the second distribution function is a continuous function.

27. The display as claimed in claim 16, wherein the product of the first distribution function and the second distribution function is a continuous function.

28. The display as claimed in claim 16, wherein the ratio of the difference between the highest brightness and the lowest brightness supplied by the light module to the highest brightness supplied by the light module is within the range of 30% to 70%.

29. The display as claimed in claim 16, wherein the ratio of the index of the transmissive or the reflective of the center pixel to the index of the transmissive or the reflective of the outermost pixel is between 0.2 and 5.

30. The display as claimed in claim 16, wherein each pixel comprises a metal layer with reflective and transmissive capabilities.

31. The display as claimed in claim 16, wherein each pixel comprises a multilayered film with reflective and transmissive capabilities.
